(19) United States
(12) Patent Application Publication
(10) Pub. No.: US 2012/0130779 A1
(43) Pub. Date: May 24, 2012

(54) Content-Aware Insertion of Advertisements within a Graphical Framebuffer or Present Surface

(76) Inventors: Ronald Perez, Austin, TX (US); Piranavan Selvanandan, Toronto (CA)

(21) Appl. No.: 12/950,011

(22) Filed: Nov. 19, 2010

(51) Int. Cl. G06Q 30/00; G06F 3/048

(52) U.S. Cl. 705/14.4; 715/856

(57) ABSTRACT

A system and method are disclosed for managing the display of graphical content within a user interface window of a display. A first set of messaging content data is processed to render a first set of graphics data in a target area of the display. The presence of a second set of rendered graphics data is detected and defined as a target area of the display. The second set of rendered graphics data in the target area of the display is replaced by the first set of rendered graphics data.

### BACKGROUND OF THE INVENTION

1. Field of the Invention

Embodiments of the invention relate generally to information processing systems. More specifically, embodiments of the invention provide a system and a method for managing the display of graphical content within a user interface window of a display.

2. Description of the Related Art

Advertising is commonly defined as a form of communication intended to persuade a target audience to take an action. In many cases, that action may be to purchase, or use, a product or service. In other cases, the action may be to embrace an ideal or to encourage a call to action. Such advertising typically includes the name, branding, or other identification of the advertiser, who usually pays for, or sponsors, the cost of its production and distribution.

It is not uncommon for commercial advertisers to seek increased consumption of their products or services through branding, which generally involves the repetition of an image or product name in an effort to build brand awareness. There are many ways to build brand awareness, but modern advertising typically relies upon mass media, which can be defined as any media meant to reach a large target audience. Traditional mass media includes newspapers, magazines, television, radio, outdoor, and direct mail. In recent years, the delivery of advertising through new media has become common. New media may be static, such as a dedicated website, or dynamic, which may include website pop-up, pop-over and pop-under advertisements that are generated, or presented, “on-the-fly” to target a specific viewer profile. More recently, social media, which is oriented to targeting audiences that share common attributes, is gaining popularity along with the delivery of advertising messages to a user's mobile device. In some cases the two are combined to target specific mobile audiences.

However, current computing allows for advertisements on web pages and various other applications to be dismissed or closed. As an example, many web browsers now incorporate “pop-up blockers” that prevent pop-up, pop-over and pop-under advertisements from being displayed. When this happens, advertisers lose the exposure to their target audience that they have paid for. It is also not uncommon for competing advertisers to have their respective advertisements presented concurrently and adjacent to one another, diluting their effectiveness. Yet another issue is when the manufacturer of a hardware device, such as a computer system, monitor, or mobile device, enables the viewing of a competitor's advertisement, thereby diluting their own brand equity. In view of the foregoing, there is a need for ensuring that the presentation of advertisements is not subverted.

### SUMMARY OF EMBODIMENTS OF THE INVENTION

A system and method are disclosed for managing the display of graphical content within a user interface window of a display. In various embodiments, a content-aware graphics driver is implemented to manage the display of messaging content data, such as advertising content data, within a user interface of a display. In these and other embodiments a first set of advertising content data is processed to render a first set of graphics data as a first graphical image in a target area of the display.

In various embodiments, the content-aware graphics driver detects the presence of a second set of graphics data rendered as a second graphical image in the user interface of the display. In these and other embodiments, the content-aware graphics driver defines the detected area as a target area of the display. In one embodiment, the second set of rendered graphics data is the same as the first set of rendered graphics data, but is concealed. In another embodiment, the second set of rendered graphics data is visible, but different than the first set of rendered graphics data. In both of these embodiments, the content-aware graphics driver replaces the second set of rendered graphics data with the first set of graphics data.

In one embodiment, the content-aware graphics driver detects the absence of a second set of rendered graphics data within the user interface of the display. The content-aware graphics driver then defines the detected area of the display as a target area of the display. In another embodiment the content-aware graphics driver defines an area proximate to a cursor in the user interface of the display as a target area. In both of these embodiments, the first set of graphics data is then rendered in the target area. In one embodiment, a second set of rendered graphics data is detected by the content-aware graphics driver. As a cursor is place proximate to the second set of rendered graphics data, it is concealed. In another embodiment, as the cursor is place proximate to the second set of rendered graphics data, the first set of graphics data is in turn rendered proximate to the cursor.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating an information processing system as implemented in accordance with an embodiment of the invention;

FIGS. 2a-b show the implementation of a content-aware graphics driver with a graphical user interface to replace a concealed graphical image with another graphical image;

FIGS. 3a-b show the implementation of a content-aware graphics driver with a graphical user interface to render a graphical image in an unused area of a display;

FIGS. 4a-b show the implementation of a content-aware graphics driver with a graphical user interface to replace one graphical image with another graphical image;

FIG. 5 shows the implementation of a content-aware graphics driver with a graphical user interface to render a set of graphics data into a graphical image proximate to a cursor;

FIG. 6 shows the implementation of a content-aware graphics driver with a graphical user interface to render a set of graphics data into an alternative graphical image proximate to a cursor that is in turn proximate to an original graphical image;

FIGS. 7a-b show the implementation of a content-aware graphics driver with a graphical user interface to conceal a graphical image when a cursor is proximate to the graphical image; and

FIGS. 8a-b are a generalized flowchart of the operation of a content-aware graphics driver to manage the display of graphical content.

### DETAILED DESCRIPTION

A system and method are disclosed for managing the display of graphical content, such as advertisements, within a user interface window of a display. Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

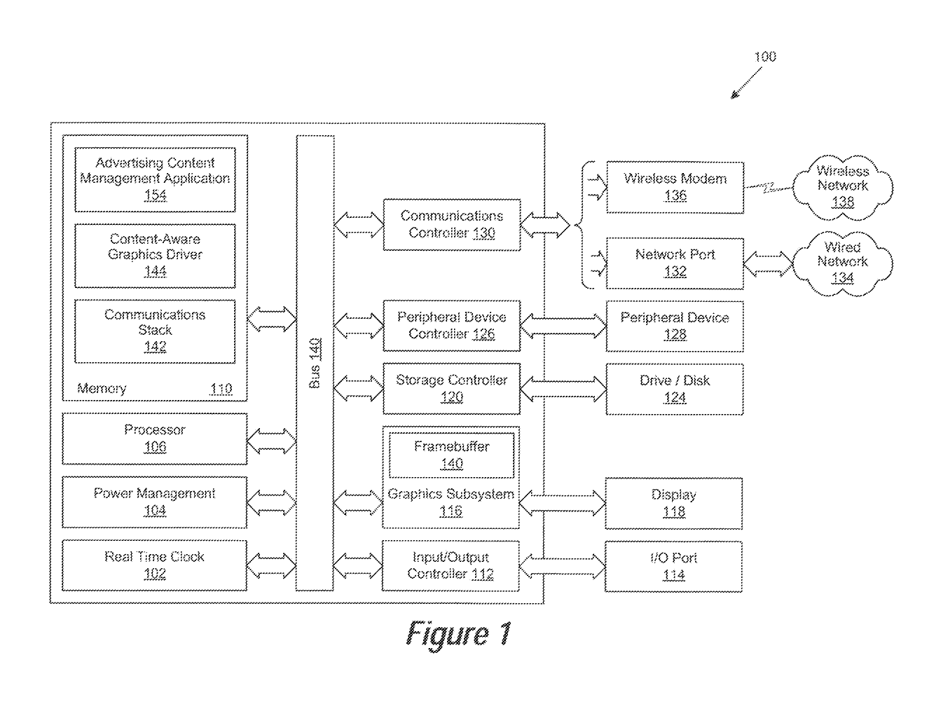

FIG. 1 is a generalized block diagram illustrating an information processing system 100 as implemented in accordance with an embodiment of the invention. System 100 comprises a real-time clock 102, a power management module 104, a processor 106 and memory 110, all physically coupled via bus 140. In various embodiments, memory 110 comprises volatile random access memory (RAM), non-volatile read-only memory (ROM), non-volatile flash memory, or any combination thereof. In one embodiment, memory 110 also comprises communications stack 142, Content-Aware Graphics Driver 144 and Advertising Content Management Application 154.

Also physically coupled to bus 140 is an input/out (I/O) controller 112, further coupled to a plurality of I/O ports 114. In different embodiments, I/O port 114 may comprise a keyboard port, a mouse port, a parallel communications port, an RS-232 serial communications port, a gaming port, a universal serial bus (USB) port, an IEEE1394 (Firewire) port, or any combination thereof. Graphics subsystem 116 is likewise physically coupled to bus 140 and further coupled to display 118. In various embodiments, the graphics subsystem 116 comprises a Framebuffer 140. In one embodiment, display 118 is separately coupled, such as a stand-alone, flat panel video monitor. In another embodiment, display 118 is directly coupled, such as a laptop computer screen, a tablet PC screen, or the screen of a personal digital assistant (PDA). Likewise physically coupled to bus 140 is storage controller 120 which is further coupled to mass storage devices such as a tape drive or hard disk 124. Peripheral device controller is also physically coupled to bus 140 and further coupled to peripheral device 128, such as a random array of independent disk (RAID) array or a storage area network (SAN).

In one embodiment, communications controller 130 is physically coupled to bus 140 and is further coupled to network port 132, which in turn couples the information processing system 100 to one or more physical networks 134, such as a local area network (LAN) based on the Ethernet standard. In other embodiments, network port 132 may comprise a digital subscriber line (DSL) modem, cable modem, or other broadband communications system operable to connect the information processing system 100 to network 134. In these embodiments, network 134 may comprise the public switched telephone network (PSTN), the public Internet, a corporate intranet, a virtual private network (VPN), or any combination of telecommunication technologies and protocols operable to establish a network connection for the exchange of information.

In another embodiment, communications controller 130 is likewise physically coupled to bus 140 and is further coupled to wireless modem 136, which in turn couples the information processing system 100 to one or more wireless networks 138. In one embodiment, wireless network 138 comprises a personal area network (PAN), based on technologies such as Bluetooth or Ultra Wideband (UWB). In another embodiment, wireless network 138 comprises a wireless local area network (WLAN), based on variations of the IEEE 802.11 specification, often referred to as WiFi. In yet another embodiment, wireless network 138 comprises a wireless wide area network (WWAN) based on an industry standard including two and a half generation (2.5G) wireless technologies such as global system for mobile communications (GPRS) and enhanced data rates for GSM evolution (EDGE). In other embodiments, wireless network 138 comprises WWANs based on existing third generation (3G) wireless technologies including universal mobile telecommunications system (UMTS) and wideband code division multiple access (W-CDMA). Other embodiments also comprise the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

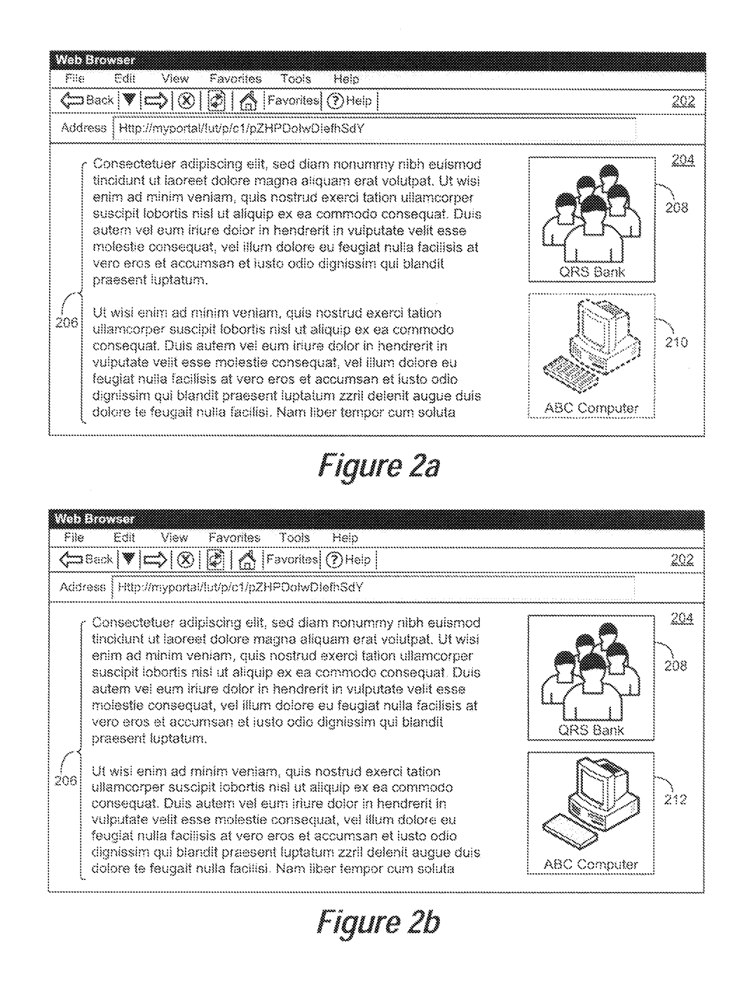

FIGS. 2a-b show the implementation of a content-aware graphics driver with a graphical user interface to replace a concealed graphical image with another graphical image. In various embodiments, a content-aware graphics driver is implemented to manage the display of graphical content, such as advertisements, within a display of a device. In this embodiment, a web browser 202 is implemented within a display and comprises a user interface window 204 comprising a body of text 206, a visible graphical image 208, and a concealed graphical image 210. As shown in FIG. 2a, the concealed graphical image 210, which may comprise a pop-up, pop-over, or pop-up window, may have been concealed through the implementation of a pop-up blocker, a host blocker, or simply being obstructed by another user interface window being opened. Those of skill in the art will realize that the concealed graphical image 210 may be concealed for many reasons and the foregoing is provided for illustrative purposes only and is not intended to limit the spirit, scope, or intent of the invention.

Referring now to FIG. 2b, the content-aware graphics driver processes data associated with the concealed graphical image 210 to determine if it contains advertising content. If so, then the content-aware graphics driver first defines the detected area of the concealed graphical image 210 as a target area of the user interface window 204. The content-aware graphics driver then determines if advertising content data corresponding to the concealed graphical image 210 is available. In various embodiments, the advertising content data is provided by an advertising content management application. In these and other embodiments, the advertising content management application may receive the advertising content data over a network connection to a network, such as the Internet.

If the corresponding advertising content data is available, then the content-aware graphics driver processes the advertising content data to provide it to a graphics subsystem for rendering. The content-aware graphics driver then controls the graphics subsystem to render a corresponding set of graphics data, which is displayed as a revealed graphical image 212. In various embodiments, the set of rendered graphics data is stored in a memory of the graphics subsystem such as a framebuffer. As used herein, a framebuffer refers to a video output device that drives a video display from a memory buffer containing a complete frame of video data.

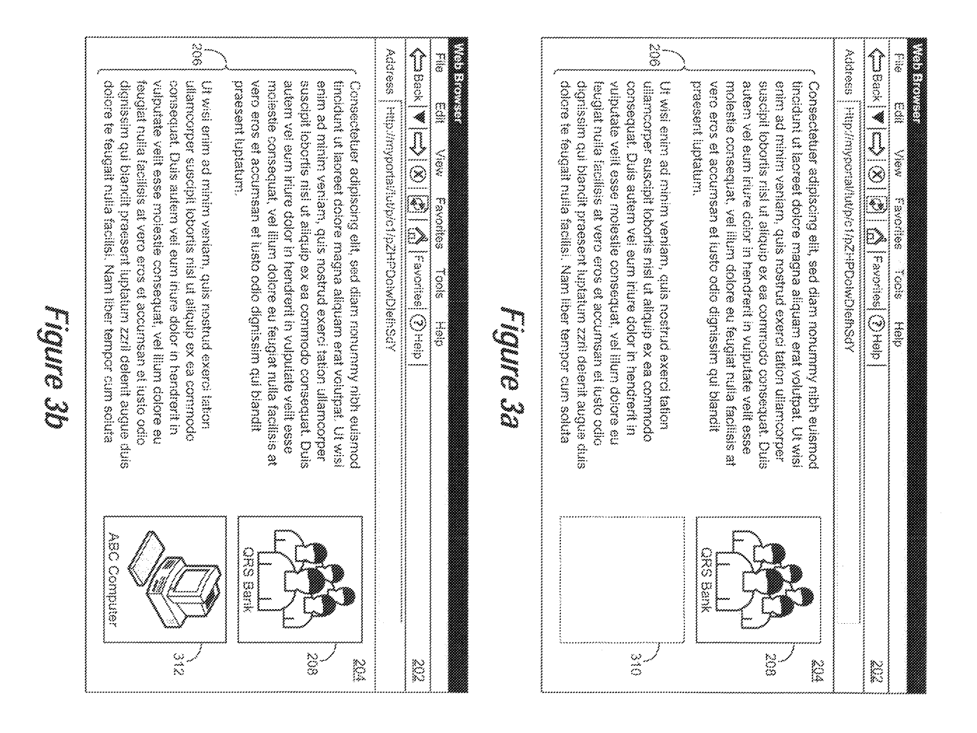

FIGS. 3a-b show the implementation of a content-aware graphics driver with a graphical user interface to render a graphical image in an unused area of a display. In this embodiment, a web browser 202 is implemented within a display and comprises a user interface window 204 comprising a body of text 206, a visible graphical image 208, and an unused area 310 of the user interface window 204. Referring now to FIG. 3a, the content-aware graphics driver defines the unused area 310 of the user interface window 204 as a target area of the user interface window 204. The content-aware graphics driver then processes predetermined advertising content data and provides it to a graphics subsystem for rendering. Thereafter, the content-aware graphics driver controls the graphics subsystem to render a set of graphics data, which is displayed as shown in FIG. 3b as a graphical image 312.

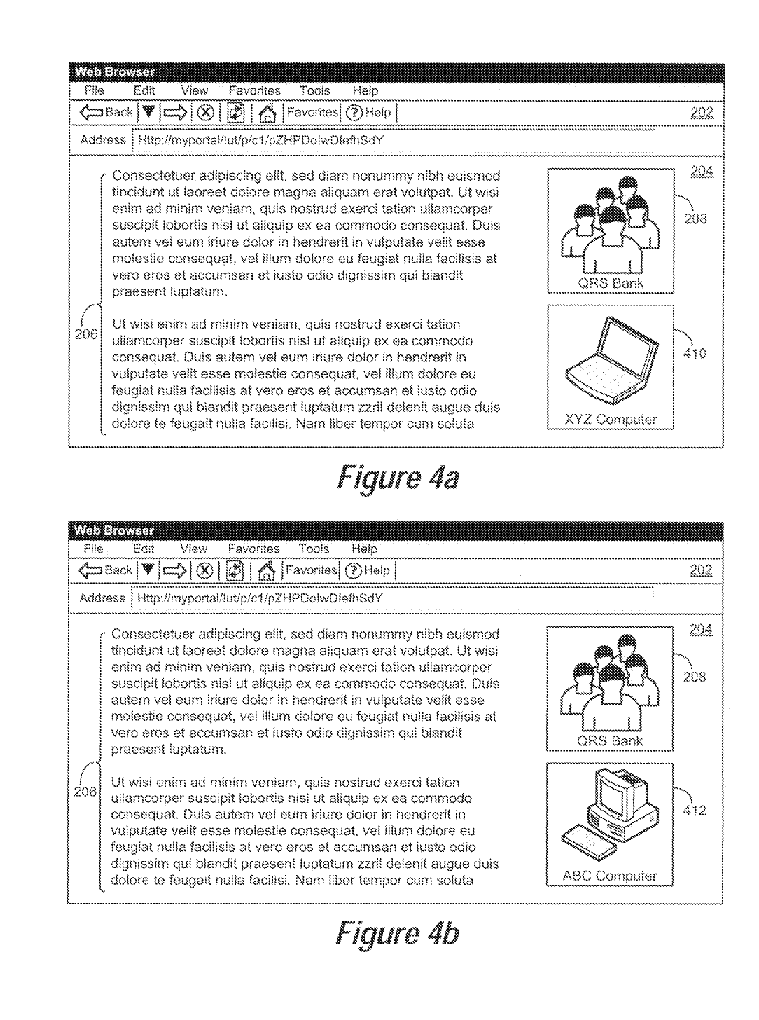

FIGS. 4a-b show the implementation of a content-aware graphics driver with a graphical user interface to replace one graphical image with another graphical image. In this embodiment, a web browser 202 is implemented within a display and comprises a user interface window 204 comprising a body of text 206, a visible graphical image 208, and an original graphical image 410.

As shown in FIG. 4a, the content-aware graphics driver processes data associated with an original graphical image 410 to determine if it contains advertising content. If so, then the content-aware graphics driver first defines the detected area of the original graphical image 410 as a target area of the user interface window 204. The content-aware graphics driver then compares advertising content data corresponding to the original graphical image 410 to available advertising content data to see if it should be replaced. As an example, the original graphical image 410 may be an advertisement for a competitor of the manufacturer of the computer the user is using.

If it is determined that the first graphical image 410 should be replaced, and if it is determined that replacement advertising content data is available, the content-aware graphics driver processes the replacement advertising content data to provide it to a graphics subsystem for rendering. The content-aware graphics driver then controls the graphics subsystem to render a corresponding set of graphics data, which is displayed as a replacement graphical image 412 as shown in FIG. 3b.

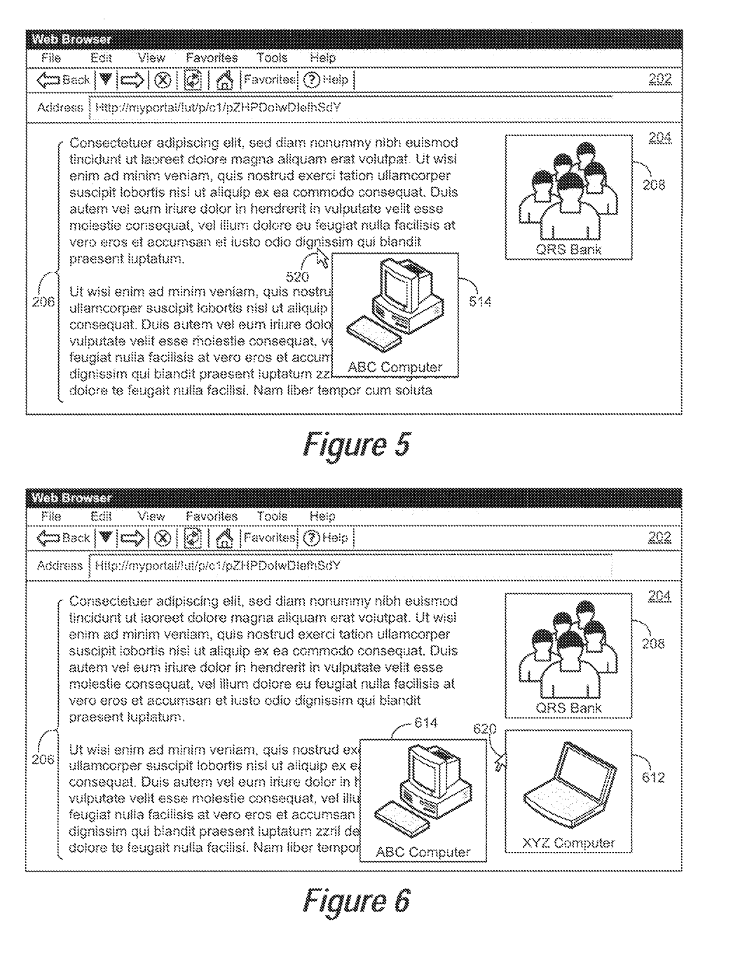

FIG. 5 shows the implementation of a content-aware graphics driver with a graphical user interface to render a set of graphics data into a graphical image proximate to a cursor. In this embodiment, a web browser 202 is implemented within a display and comprises a user interface window 204 comprising a body of text 206, a visible graphical image 208, and a cursor 520. Referring now to FIG. 5, the content-aware graphics driver defines an area proximate to cursor 520 as a target area of the user interface window 204. The content-aware graphics driver then processes predetermined advertising content data and provides it to a graphics subsystem for rendering. Thereafter, the content-aware graphics driver controls the graphics subsystem to render a set of graphics data, which is displayed as a graphical image 514. In various embodiments, the graphical image 514 is displayed for a predetermined time period.

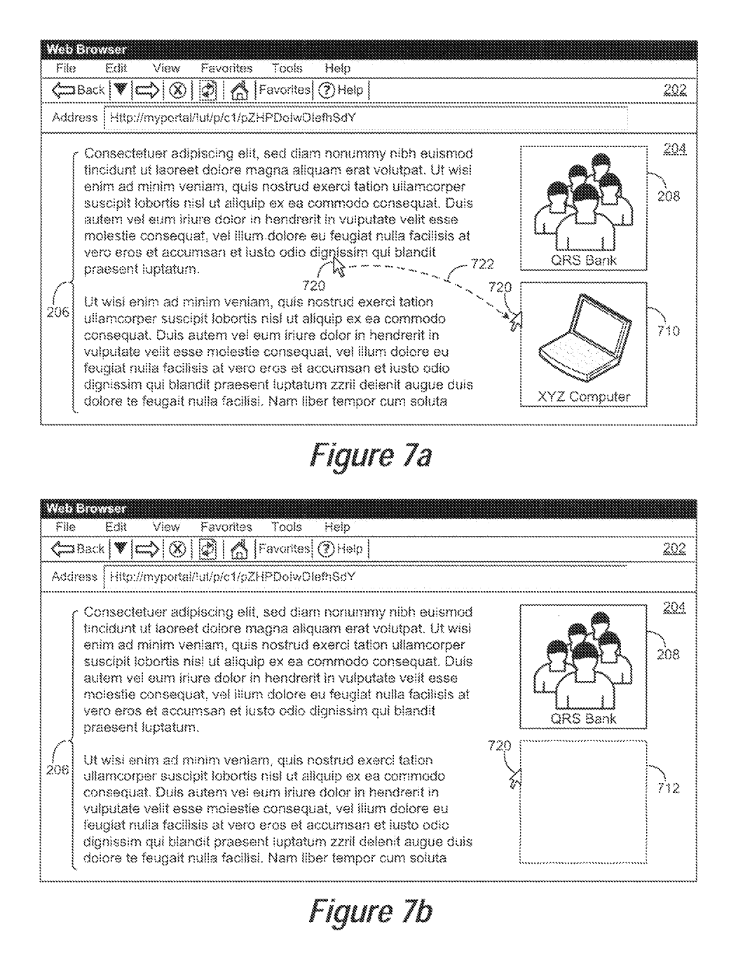

FIG. 6 shows the implementation of a content-aware graphics driver with a graphical user interface to render a set of graphics data into an alternative graphical image proximate to a cursor that is in turn proximate to an original graphical image. In this embodiment, a web browser 202 is implemented within a display and comprises a user interface window 204 comprising a body of text 206, a visible graphical image 208, an original graphical image 610, and a cursor 620.

Referring now to FIG. 6, the content-aware graphics driver processes data associated with the original graphical image 612 to determine if it contains advertising content. If so, then the content-aware graphics driver determines whether advertising content data corresponding to an alternative graphical image is available. If so, then a determination is made whether the alternative graphical image should be rendered proximate to the cursor 620 when it is proximate to the original graphical image 620.

If so, the content-aware graphics driver defines an area proximate to cursor 620 as a target area of the user interface window 204. The content-aware graphics driver then compares advertising content data corresponding to the original graphical image 612 to available advertising content data. As an example, the original graphical image 612 may be an advertisement for a competitor of the manufacturer of the computer the user is using.

If it is determined that alternative advertising content data is available, the content-aware graphics driver processes the alternative advertising content data to provide it to a graphics subsystem for rendering. The content-aware graphics driver then processes predetermined advertising content data and provides it to a graphics subsystem for rendering. Thereafter, the content-aware graphics driver controls the graphics subsystem to render a set of graphics data, which is displayed as an alternative graphical image 614 when cursor 620 is proximate to the original graphical image 612.

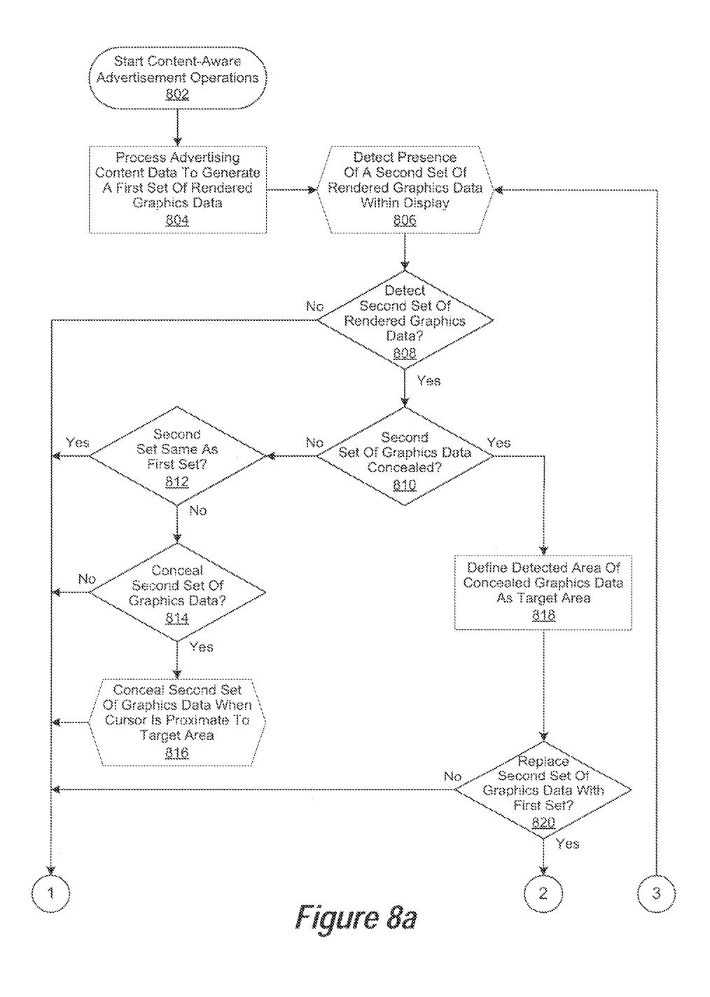

FIGS. 7a-b show the implementation of a content-aware graphics driver with a graphical user interface to conceal a graphical image when a cursor is proximate to the graphical image. In this embodiment, a web browser 202 is implemented within a display and comprises a user interface window 204 comprising a body of text 206, a visible graphical image 208, an original graphical image 710, and a cursor 720.

Referring now to FIG. 7, the content-aware graphics driver processes data associated with the original graphical image 710 to determine if it contains advertising content. If so, then the content-aware graphics driver determines whether the original graphical image 710 should be concealed when the cursor 620 is proximate to the original graphical image 710. If so, then the content-aware graphics driver first defines the detected area of the original graphical image 710 as a target area of the user interface window 204. Then, as cursor 720 is moved 722 proximate to the original graphical image 710, the content-aware graphics driver controls the graphics subsystem to render a set of graphics data to generate a concealing graphical image 712 as shown in FIG. 7b to conceal the original graphical image 710

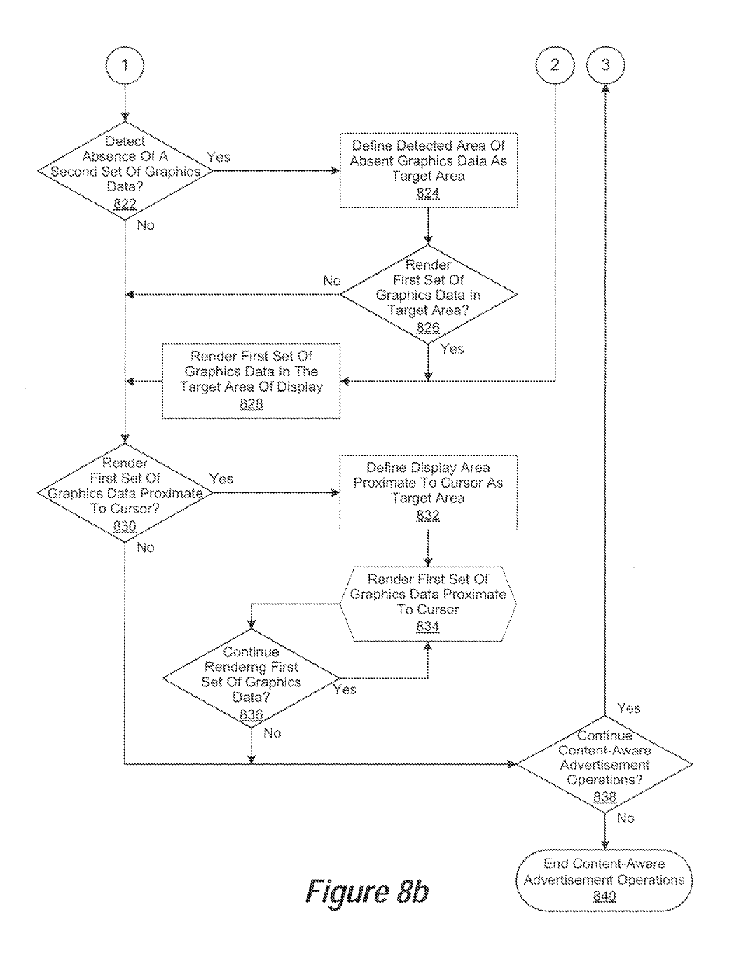

FIGS. 8a-b is a generalized flowchart of the operation of a content-aware graphics driver to manage the display of graphical content. In this embodiment, content-aware advertisement operations are begun in step 802. In step 804, advertising content data is processed, as described in greater detail herein, to generate a first set of rendered graphics data, which as likewise described in greater detail herein, is displayed as a graphical image within a user interface of a display. Operations are then performed by a content-aware graphics driver in step 806 to detect a second set of rendered graphics data, which is likewise displayed as a graphical image within a user interface of the display.

A determination is then made in step 808 whether the content-aware graphics driver has detected a second set of rendered graphics data. If so, then a determination is made in step 810 whether the second set of rendered graphics data is concealed. If so, then the content-aware graphics driver defines the detected area of the second set of rendered graphics data as a target area of the display. A determination is then made in step 820 whether to replace the second set of rendered graphics data with the first set of rendered graphics data. If so, then the first set of graphics data is rendered in the target area of the display in step 828 as described in greater detail herein.

However, if it is determined in step 810 that the second set of rendered graphics data is not concealed, then a determination is made by the content-aware graphics driver in step 812 whether the second set of rendered graphics data is the same as the first set of rendered graphics data. If not, then a determination is made in step 814 whether to conceal the second set of rendered graphics data. If so, then the second set of rendered graphics data is concealed in step 816 as described in greater detail herein.

Thereafter, or if it was determined in step 808 that a second set of rendered graphics data was not detected, or in step 812 that the second set of rendered graphics data was no the same as the first set of rendered graphics data, or in step 814 not to conceal the second set of rendered graphics data, or in step 820 not to replace the second set of rendered graphics data with the first set of graphics data, then a determination is made in step 822 whether the content-aware graphics driver has detected the absence of a second set of rendered graphics data within the user interface window of the display. If so, then the content-aware graphics driver defines the detected area of the absent second set of rendered graphics data as a target area of the display in step 824. A determination is then made in step 826 whether to render the first set of graphics data in the target area. If so, then the first set of graphics data is rendered in step 828 as a graphical image in the target image. Thereafter, or if it was determined in step 822 that the absence of a second set of rendered graphics detail was not detected, or in step 826 not to render the first set of graphics data in the target area, then a determination is made in step 830 whether to render the first set of graphics data proximate to a cursor, as described in greater detail herein. If so, then the content-aware graphics driver defines a display area proximate to the cursor as a target area of the display in step 832, followed by rendering the first set of graphics data in the target area in step 832. A determination is then made in step 836 whether to continue rendering the first set of graphics data in the target area. If so, the process is continued, proceeding with step 834. Otherwise, or if it was determined in step 830 not to render the first set of graphics data proximate to the cursor, then a determination is made in step 838 whether to continue content-aware advertisement operations. If so, the process is continued, proceeding with step 806. Otherwise, content-aware advertisement operations are ended in step 840.

Skilled practitioners in the art will recognize that many other embodiments and variations of the present invention are possible.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein.

Also, for example, it will be appreciated that a level of interactivity could be added to extend the advertising value of the image. For example, the interactivity could include an image which is actuatable (e.g., surface clickable). In certain embodiments, a software process could launch a universal resource locator (URL) for a website in response to actuation of the image. Similarly, a driver could render other user interface (UI) elements such as a button that can be actuated by rendering a button image and using a mouse position to determine an action for the button actuation.

Also, it will be appreciated that the term image includes an image used in the context of motion video (e.g., a movie or animation) as well as any shader or special effect that is applied to an image to cause the image to be animated. Thus, the term image includes any use if the image within a richer media experience.

Also for example, while the invention is advantageous for advertising content, other messaging content is also contemplated such as messaging content which includes network messages or warning messages.

In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for managing the display of advertising content, comprising:
a graphics subsystem operable to render graphics data; and
driver software operable to process messaging content data and further operable to control the graphics subsystem to display the processed messaging content data as a first set of rendered graphics data in a target area of a display.

2. The system of claim 1, wherein:
the messaging content data comprises advertising content data.

3. The system of claim 1, wherein the driver software is further operable to:
detect the concealment of a second set of rendered graphics data within an area of the display;
define the detected area of the display as the target area of the display; and
control the graphics subsystem to render the first set of rendered graphics data in place of the concealed second set of rendered graphics data in the target area of the display.

4. The system of claim 1, wherein the driver software is further operable to:
determine the absence of a second set of rendered graphics data within a detected area of the display;
define the detected area of the display as the target area of the display; and
control the graphics subsystem to render the first set of rendered graphics data in the target area of the display.

5. The system of claim 1, wherein the driver software is further operable to:
determine the presence of a second set of rendered graphics data within a detected area of the display;
define the detected area of the display as the target area of the display; and
control the graphics subsystem to render the first set of rendered graphics data in place of the second set of rendered graphics data in the target area of the display.

6. The system of claim 1, wherein the driver software is further operable to:
detect the presence of a second set of rendered graphics data within an area of the display;
define the detected area of the display as the target area of the display; and
control the graphics subsystem to conceal the second set of rendered graphics data when the cursor is proximate to the target area of the display.

7. The system of claim 1, wherein the driver software is further operable to:
determine the position of a cursor within an area of the display;
define an area proximate to the position of the cursor as the target area of the display; and
control the graphics subsystem to render the first set of rendered graphics data in the target area of the display proximate to the cursor.

8. A computer-implemented method for managing the display of messaging content, comprising:
providing a graphics subsystem operable to render graphics data, wherein the graphics subsystem; and,
processing messaging content data via driver software to control the graphics subsystem to display the processed messaging content data as a first set of rendered graphics data in a target area of the display.

9. The computer-implemented method of claim 8, wherein:
the messaging content data comprises advertising content data.

10. The computer-implemented method of claim 8, further comprising:
detecting concealment of a second set of rendered graphics data within an area of the display;
defining the detected area of the display as the target area of the display; and
controlling the graphics subsystem to render the first set of rendered graphics data in place of the concealed second set of rendered graphics data in the target area of the display.

11. The computer-implemented method of claim 8, further comprising:
determining an absence of a second set of rendered graphics data within a detected area of the display;
defining the detected area of the display as the target area of the display; and
controlling the graphics subsystem to render the first set of rendered graphics data in the target area of the display.

12. The computer-implemented method of claim 8, further comprising:
determining a presence of a second set of rendered graphics data within a detected area of the display;
defining the detected area of the display as the target area of the display; and
controlling the graphics subsystem to render the first set of rendered graphics data in place of the second set of rendered graphics data in the target area of the display.

13. The computer-implemented method of claim 8, further comprising:
detecting a presence of a second set of rendered graphics data within an area of the display;
defining the detected area of the display as the target area of the display; and
controlling the graphics subsystem to conceal the second set of rendered graphics data when the cursor is proximate to the target area of the display.

14. The computer-implemented method of claim 8, further comprising:
determining a position of a cursor within an area of the display;
defining an area proximate to the position of the cursor as the target area of the display; and
controlling the graphics subsystem to render the first set of rendered graphics data in the target area of the display proximate to the cursor.

15. A non-transitory computer-usable medium embodying computer program code, the computer program code comprising computer executable instructions configured for:
rendering graphics data via a graphics subsystem; and,
processing messaging content data via driver software to control the graphics subsystem to display the processed messaging content data as a first set of rendered graphics data in a target area of the display.

16. The non-transitory computer-usable medium of claim 13, wherein:
the messaging content data comprises advertising content data.

17. The non-transitory computer-usable medium of claim 15, wherein the driver software is further operable to:
detect the concealment of a second set of rendered graphics data within an area of the display;
define the detected area of the display as the target area of the display; and
control the graphics subsystem to render the first set of rendered graphics data in place of the concealed second set of rendered graphics data in the target area of the display.

18. The non-transitory computer-usable medium of claim 15, wherein the driver software is further operable to:
determine the absence of a second set of rendered graphics data within a detected area of the display;
define the detected area of the display as the target area of the display; and
control the graphics subsystem to render the first set of rendered graphics data in the target area of the display.

19. The non-transitory computer-usable medium of claim 15, wherein the driver software is further operable to:
determine the presence of a second set of rendered graphics data within a detected area of the display;
define the detected area of the display as the target area of the display; and
control the graphics subsystem to render the first set of rendered graphics data in place of the second set of rendered graphics data in the target area of the display.

20. The non-transitory computer-usable medium of claim 15, wherein the driver software is further operable to:
detect the presence of a second set of rendered graphics data within an area of the display;
define the detected area of the display as the target area of the display; and
control the graphics subsystem to conceal the second set of rendered graphics data when the cursor is proximate to the target area of the display.

21. The non-transitory computer-usable medium of claim 15, wherein the driver software is further operable to:
determine the position of a cursor within an area of the display;
define an area proximate to the position of the cursor as the target area of the display; and
control the graphics subsystem to render the first set of rendered graphics data in the target area of the display proximate to the cursor.

22. The non-transitory computer-usable medium of claim 15, wherein the first set of rendered graphics data is stored in a framebuffer.
